(19) United States
(12) Patent Application Publication
(10) Pub. No.: US 2024/0386283 A1
(43) Pub. Date: Nov. 21, 2024

(54) METHOD AND SYSTEM FOR CONFIGURING THE NEURAL NETWORKS OF A SET OF NODES OF A COMMUNICATION NETWORK

(71) Applicant: Orange, Issy-les-Moulineaux (FR)

(72) Inventors: Hugo Miralles, CHATILLON CEDEX (FR); Tamara Tosic, CHATILLON CEDEX (FR)

(21) Appl. No.: 18/688,006

(22) PCT Filed: Aug. 29, 2022
(86) PCT No.: PCT/FR2022/051617

§ 371 Date: Feb. 29, 2024

(30) Foreign Application Priority Data
Aug. 30, 2021 (FR) 2109043

(51) Int. Cl. G06N 3/098

(52) U.S. Cl. CPC G06N 3/098

(57) ABSTRACT

A method allows configuration of the weights of neural network models of nodes from a set of nodes of a communication network, the neural networks all having a model with the same structure. The method includes partitioning the set of nodes into a cluster of nodes and sending, to a node belonging to the cluster, an item of information according to which the node should act as an aggregation node in the cluster and identifiers of the nodes of the cluster. The method also includes sending, to the aggregation node of the cluster, a request for learning the weights of the node models of the cluster with the weights of a global model for the set of nodes, receiving, from the aggregation node of the cluster, the weights of an aggregated model of the cluster resulting from the training, and updating the weights of the global model by aggregating the weights received from the aggregated model of the cluster.

### FIELD OF THE INVENTION

The invention concerns the telecommunications networks. It relates to the learning of neural networks implemented by devices connected to a communication network.

### PRIOR ART

The invention more specifically lies in the context of federated learning in which devices locally train models of neural networks of the same structure and share the learnings carried out on their devices with the other devices.

The federated learning is opposed to the centralized learning where the learning is done centrally, for example on the servers of a service provider.

For more information on the federated learning, those skilled in the art may refer to the document «Brendan McMahan, E. Moore, D. Ramage, S. Hampson, and B. Agüera y Arcas, “Communication-efficient learning of deep networks from decentralized data,” Proceedings of the 20^{th} International Conference on Artificial Intelligence and Statistics, AISTATS 2017, vol. 54, 2017 ».

The federated learning can for example be favored over the centralized learning when it is difficult to envisage a global centralized model adapted to all devices.

The use of a federated learning can also be advantageous when the devices are likely to train their models with data which distribution is likely to depend on, at least to a certain extent, on these devices.

In recent years, the federated learning approach has attracted a lot of interest in many fields, such as healthcare, banking, industry 4.0 or smart cities, because it can help build better global models, while preserving the confidentiality of the local files (medical, financial files, etc.). It can provide a natural solution to the growing needs for personal data protection, while addressing the current technological challenges: decrease in the energy consumption, minimization of the latency, two challenges with the deployment of 5G technology. As explained above, the federated learning is thus a form of distributed learning where several nodes collaboratively solve a machine learning task.

For some applications, the data collected by the users in real contexts often have non-«independent and identically distributed» (IID) distributions (unlike random variables following the same probability law), which can have a significant impact on the convergence of the models, during a federated learning, in particular when a single joint model may not correspond to the objective of each node.

### OBJECT AND SUMMARY OF THE INVENTION

According to a first aspect, the invention concerns a method for configuring models of neural networks of nodes from a set of nodes of a communication network, the neural networks of said nodes all having the same structure.

In particular, the invention concerns a method for configuring weights of models of neural networks (NN) of the same structure, of nodes from a set of nodes of a communication network, said method including a federated learning of said weights in which said nodes locally train their model of neural networks and share the weights of their model with other nodes of said network, the method including:
at least one partition of the set of nodes into at least one cluster of nodes;
a designation of at least a first node of said cluster for a role of aggregation node managing an aggregate model of said at least one cluster of nodes for said federated learning, said designation comprising:
   sending, to the nodes of said cluster, information designating said first node as an aggregation node;
   sending, to the first node, the identifiers of the nodes of said cluster.

In at least one embodiment, said designation is temporary, the method comprising at least one other designation for at least one other partition of said set of nodes.

In at least one embodiment, the configuration method comprises, during said federated learning:
sending, to the aggregation node of said at least one cluster, a request to learn the weights of the models of the nodes of said cluster with the weights of a global model to the set of nodes;
receiving, from the aggregation node of said at least one cluster, the weights of said aggregate model of said cluster resulting from said learning; and
updating the weights of the global model by aggregation of the received weights of the aggregate model of said at least one cluster.

In at least one embodiment, the configuration method includes a partition of the set of nodes into at least one cluster by taking into account a communication cost between the nodes within said at least one cluster.

In at least one embodiment, the configuration method includes a partition of the set of nodes to reorganize said clusters into at least one cluster, said reorganized clusters being constituted according to a function taking into account a communication cost between the nodes within a reorganized cluster and a similarity of a change in the weights of the models of the nodes within a reorganized cluster.

In at least one embodiment, said similarity is determined by:
asking said nodes to replace the weights of their model with the weights of the updated global model;
asking said nodes to update their model by training it with their local dataset; and by
determining a similarity of the changes in the weights of the models of the different nodes.

In at least one embodiment, the configuration method includes:
receiving, from the aggregation node of a first cluster, an identifier of an isolated node of said first cluster; and
reallocating said isolated node to another cluster, by taking into account a proximity between:
   a direction of the change in the weights of said isolated node when it is trained by local data to the isolated node; and.
   a direction of the change in the weights of the aggregate model of said other cluster, compared to the same reference model.

In at least one embodiment, the configuration method includes:
at least partitioning the set of nodes into at least one cluster (or group) of nodes;
sending, to a node belonging to said at least one cluster, information according to which this node must play the role of aggregation node in this cluster and identifiers of the nodes of this cluster, said node then being referred to as aggregation node of the cluster;
sending, to the aggregation node of said at least cluster, a request to learn the weights of the models of the nodes of said cluster with the weights of a global model to the set of nodes;
receiving, from the aggregation node of said at least one cluster, the weights of an aggregate model of said cluster resulting from this learning; and
updating the weights of the global model by aggregation of the received weights of the aggregate model of said at least one cluster.

Correlatively, the invention relates to a coordination entity able to configure models of neural networks of nodes from a set of nodes of a communication network, the neural networks of said nodes all having a model of the same structure,

In particular, the invention concerns a coordination entity able to configure weights of models of neural networks of the same structure, of nodes from a set of nodes of a communication network, by federated learning of said weights in which said nodes locally train their models of neural networks and share the weights of their model with other nodes of said network, said coordination entity comprising at least one processor capable of:
at least one partition of the set of nodes into at least one cluster of nodes;
a designation of at least one first node of said cluster for a role of aggregation node managing an aggregate model of said at least one cluster of nodes for said federated learning, said designation comprising:
   sending, to the nodes of said cluster, information designating said first node as an aggregation node;
   sending, to the first node, identifiers of the nodes of said cluster.

According to at least one embodiment, the coordination entity comprises:
a module for sending, to said aggregation node of said at least one cluster, a request to learn the weights of the models of the nodes of said cluster with the weights of a global model to the set of nodes;
a module for receiving, from the aggregation node of said at least one cluster, the weights of an aggregate model of said cluster resulting from said learning; and
a module for updating the weights of the global model by aggregation of the received weights of the aggregate model of said at least one cluster.

According to at least one embodiment, said coordination entity includes:
a module for partitioning the set of nodes into at least one cluster of nodes;
a module for sending, to a node belonging to said at least one cluster, information according to which this node must play the role of aggregation node in said cluster, and identifiers of the nodes of this cluster, said node then being referred to as cluster aggregation node;
a module for sending, to the aggregation node of said at least one cluster, a request to learn the weights of the models of the nodes of said cluster with the weights of a global model to the set of nodes;
a module for receiving, from the aggregation node of said at least one cluster, the weights of an aggregate model of this cluster resulting from said learning; and
a module for updating the weights of the global model by aggregation of the received weights of the aggregate model of said at least one cluster.

According to a second aspect, the invention concerns a learning method implemented by a node from a set of nodes of a communication network.

In particular, the invention concerns a learning method implemented by a node from a set of nodes including neural networks having a model of the same structure, of a communication network, said method including, before federated learning of the weights of said models of the neural networks of the nodes of said set, in which said nodes locally train their model of neural networks and share the weights of their model with other nodes called aggregation nodes of said network:
receiving, from an entity of said communication network, information designating a first node from said set as an aggregation node managing an aggregate model for said federated learning and, when said node is said first node, identifiers of the nodes of a cluster whose said aggregation node manages said abbreviated model.

According to at least one embodiment, the learning method comprises, when said node is said aggregation node;
receiving, from said entity of said communication network, the weights of a model having said structure;
upon receipt of a request to learn the weights of an aggregate model of said cluster from said received weights;
initializing the weights of the aggregate model of said cluster and the weights of the models of the nodes of said cluster with said received weights;
at least updating the weights of the aggregate model of said cluster, by aggregation of the weights of the models of the nodes of said cluster, trained with local datasets to these nodes, the weights of the models of the nodes of said cluster being replaced by the updated weights of the aggregate model of said cluster after each update;
sending, to said entity of said network, the weights of the aggregate model of said updated cluster.

According to at least one embodiment, the learning method comprises, when said node is said aggregation node:
determining whether said cluster must be restructured by taking into account a change in the weights of said cluster and/or a change in the weights of the nodes of said cluster.

According to at least one embodiment, the learning method includes, when said node is said aggregation node; if it is determined that said cluster must be restructured, restructuring said cluster by grouping at least part of the nodes of said cluster into at least one subcluster, said subclusters being constituted according to a function taking into account a communication cost between the nodes within one said subcluster and a similarity of a change in the weights of the models of the nodes within one said subcluster.

According to at least one embodiment, said restructuring of said cluster includes sending, to said entity of said communication network, the identifier of an isolated node of said cluster.

According to at least one embodiment, the learning method comprises, when said node is not said aggregation node:
receiving, from said aggregation node, the weights of a model having said structure to initialize the weights of the model of the node;
transmitting, to said aggregation node, the weights of the model of the trained node with a local dataset to said node.

According to at least one embodiment, said method is implemented by a node belonging to a first cluster, and said entity of said communication network is:
a coordination entity of the network;
a node of said set of nodes playing the role of aggregation node managing an aggregate model of a second cluster of lower level than the level of said first cluster.

According to at least one embodiment, the invention concerns a learning method implemented by a node from a set of nodes of a communication network, said node being able to play the role of aggregation node in a cluster of nodes from the set of nodes, the nodes of this set including a neural network, the neural networks of these nodes all having a model of the same structure. This method includes:
receiving, from an entity of the communication network:
   information according to which the node must play said role of aggregation node in a cluster of nodes; and
   identifiers of the nodes of this cluster;
receiving, from the entity of the communication network, the weights of a model having said structure;
upon receipt of a request to learn the weights of an aggregate model of the cluster from these received weights:
initializing the weights of the aggregate model of the cluster and the weights of the models of the nodes of the cluster with the received weights;
at least updating the weights of the aggregate model of the cluster, by aggregation of the weights of the models of the nodes of said cluster, trained with local datasets to these nodes, the weights of the models of the nodes of said cluster being replaced by the updated weights of the aggregate model of the cluster after each update;
sending, to the entity of said network, the weights of the aggregate model of said updated cluster.

Correlatively, the invention concerns a node belonging to a set of nodes of a communication network. In particular, the invention concerns a node belonging to a set of nodes including neural networks having a model of the same structure, of a communication network, said node including at least one processor able to
receive, from an entity of said communication network, before federated learning of the weights of said models of the neural networks of the nodes of said set, in which said nodes locally train their model of neural networks and share the weights of their model with other nodes of said network, information designating a first node from said set as an aggregation node managing an aggregate model for said federated learning and, when said node is said first node, identifiers of the nodes of said cluster of a cluster whose said aggregation node manages said aggregate model.

According to at least one embodiment, the node comprises:
a module for receiving, from said entity of said communication network, the weights of a model having said structure, when said node is said aggregation node;
a module for receiving a request to learn the weights of an aggregate model of said cluster from said received weights, when said node is said aggregation node;
an initialization module configured, in case of receipt of said learning request, to initialize the weights of the aggregate model of said cluster and the weights of the models of the nodes of said cluster with the received weights, when said node is said aggregation node;
a module for updating the weights of the aggregate model of said cluster, by aggregation of the weights of the models of the nodes of said cluster, trained with local datasets to these nodes, the weights of the models of the nodes of said cluster being replaced by the updated weights of the aggregate model of said cluster after each update, when said node is said aggregation node; and
a module for sending, to said entity of the network, the weights of the aggregate model of said updated cluster, when said node is said aggregation node.

According to at least one embodiment, the invention relates to a node belonging to a set of nodes of a communication network, said node being able to play the role of aggregation node in a cluster of nodes of said set of nodes, the nodes of this set including a neural network, the neural networks from said nodes all having a model of the same structure. This node includes:
a module for receiving, from an entity of said communication network:
   information according to which said node must play said role of aggregation node in a cluster of nodes; and
   identifiers of the nodes of this cluster;
a module for receiving, from said entity of said communication network, the weights of a model having said structure;
a module for receiving a request to learn the weights of an aggregate model of the cluster from the received weights;
an initialization module configured, in case of receipt of said learning request, to initialize the weights of the aggregate model of the cluster and the weights of the models of the nodes of said cluster with the received weights;
a module for updating the weights of the aggregate model of the cluster, by aggregation of the weights of the models of the nodes of said cluster, trained with local datasets to these nodes, the weights of the models of the nodes of said cluster being replaced by the updated weights of the aggregate model of the cluster after each update; and
a module for sending, to said entity of the network, the weights of the aggregate model of the updated cluster.

According to some embodiments, the invention also targets a system including a coordination entity and at least one node as mentioned above.

The invention proposes federated learning in which nodes of the network can communicate or receive weights (or parameters) or changes in the weights of the models of their neural networks.

These nodes can be communication devices of any type. These can be in particular terminals, connected objects (IoT for Internet of Things), for example cell phones, laptops, home equipment (for example gateways), private or public equipment, particularly an operator of a telecommunications network, for example access points, core network equipment, servers dedicated to the invention or servers implementing functions of the operator for the implementation of a service in the network. The nodes Nᵢ can be fixed or mobile. These can be virtual machines.

In one embodiment, the nodes each have access to a local dataset.

Thus, the invention can be implemented, but in a non-limiting manner, within the framework of applications or services of a communication network, for which it is not possible or desirable for the devices of the network to communicate their data either to each other or to a centralized entity.
η: E: B: Locally, a node can update the weights of its model (or more simply its model), for example by performing a gradient descent based on data from its local dataset. More specifically, a gradient descent can comprise, for a node, a calculation of the gradient of a cost function by using a certain number E of times the local dataset divided into batches. Hyperparameters can be considered to parameterize a gradient descent, in particular:
η: E: B: the learning rate
η: E: B: the number of epochs
η: E: B: the size of the data batch, for example retrieved randomly.

The invention can be implemented with all types of datasets, for example when the data of the local datasets are not «independent and identically distributed » (IID) data, but non-IID data.

In one particular embodiment, the nodes are grouped (partitioned) into clusters (or groups of nodes), these being likely to vary dynamically to help, for example, the convergence of the models shared by the nodes of the same cluster.

More specifically, the partition of the nodes into clusters can vary, the structure of a cluster (namely particularly the set of nodes that compose it) is likely to vary over time.

Thus, in some particular embodiments, a coordination entity is configured to partition or repartition the set of nodes into clusters, and to designate an aggregation node in at least some of these clusters.

In some particular embodiments of the invention, at least some nodes of the set of nodes are able to play this role of aggregation node.

In some particular embodiments of the invention, when the coordination entity has defined a new partition of the nodes into clusters and designated the nodes that must play the role of aggregation node within their clusters, the coordination entity sends information to these nodes so that they play this role of aggregation node within their cluster. It also tells them the identifiers of the nodes of the cluster.

In one particular embodiment of the invention, it is considered not only that each node of a cluster includes its own model, but also that each cluster includes its own model.

In some embodiments, the aggregation node of a cluster manages the aggregate model of at least that cluster.

In one particular embodiment of the invention, each cluster includes an aggregation node which manages the aggregate model of this cluster.

In one particular embodiment of the invention, the aggregate model of a cluster is obtained by aggregation of the weights of the models of the nodes of the cluster, trained with local datasets to these nodes.

The nodes of a cluster that train their models with their local datasets and that contribute to the construction of the aggregate model of the cluster can be for example referred to as worker nodes.

In some embodiments of the invention, a node may be able to play the role of aggregator node, to play the role of worker node, or to play both roles.

In one embodiment of the invention, the role of a node can vary over the partitions, for example be redefined at each new partition.

Thus, in one particular embodiment, the learning method is implemented by a node which, in addition to being able to play the role of aggregation node, is further able to play the role of worker node. In this embodiment, an entity of the communications network can specifically inform the node that it must play the role of worker node.

As a variant, a node implicitly understands that it must play the role of worker node when it receives, from an entity of the communication network, the identifier of an aggregation node of a cluster to which it belongs.

The fact of being able to change the role of the nodes over the iterations, and particularly that worker nodes at least temporarily play the role of aggregation node, makes it possible to constitute clusters in a much more flexible way than in the methods of the prior art in which the aggregation, when it exists, is carried out by servers.

When a node plays the role of worker node, it receives, from the aggregation node of its cluster, weights of a model having the structure of the models of all the nodes of the set to initialize the weights of its own model and it transmits to this aggregation node the weights of its model trained with a local dataset to this node.

In one embodiment of the invention, the aggregation node of a cluster relays the communication between the nodes within the cluster. In this embodiment, if the communication cost between two nodes is used as a criterion (unique or not) to determine the clusters of a partition of nodes, the communication cost within a cluster can be the sum of the communication costs between the aggregation node of the cluster and each of the nodes of the cluster.

In one embodiment, to limit (for example minimize) communication costs, the aggregation node of a cluster is chosen in the vicinity of the nodes of the cluster.

In one embodiment of the invention, the aggregation node of a cluster is one of the nodes from the aforementioned set of nodes. In which case, it manages not only the model of the cluster but also its own model as described previously.

In one embodiment of the invention, the aggregation node of a cluster relays the communication between the coordination entity and the nodes of its cluster.

In some particular embodiments of the invention, the aggregation node of a cluster has the possibility to reorganize its cluster, particularly to create subclusters within its cluster or to exclude nodes from its cluster.

In one particular embodiment, several cluster levels can be used, and the model of a cluster of level n can be obtained by aggregation of the models of the clusters of level n+1. In this embodiment, the aggregation node of a cluster of level n can for example relay the communications with the aggregation nodes of the clusters of level n−1 and/or of level n+1.

In one embodiment of the invention, it can be considered that the coordination entity is an aggregation node of the lowest level, by a convention of level 0 for example.

In one embodiment of the invention, the entity of the network which sends, to a node of a cluster of level n, the information according to which this node must play said role of aggregation node in this cluster, the identifiers of the nodes of this cluster and the weights of a global model to the set of nodes is:
a coordination entity as mentioned above; or
a node which plays the role of aggregation in a cluster of level n−1.

Likewise, in one embodiment of the invention, the entity of the network which sends to a node the information according to which it must play the role of worker node in a cluster of level n and the identifier of an aggregation node of this cluster is:
a coordination entity as mentioned above; or
a node which plays the role of aggregation in a cluster of level n−1.

In one particular embodiment, the aggregate model of each cluster is sent to the cluster of lower level, for example conditionally, such as after a constant number of iterations. The aggregate models can thus go up to the coordination entity which can aggregate these models into an updated version of the overall model.

This global model can then go down to all the nodes for a new implementation of the method either directly or via the aggregation nodes.

In some embodiments of the invention, the partition of the nodes into clusters can take into account a communication cost between the nodes of at least one cluster or take into account at least one service implemented by at least one of the nodes. But other criteria can be used.

For example, In one particular embodiment of the invention, the clusters of the partition of the nodes (in the initial partition for example) are determined to minimize a communication cost between the nodes of this cluster. But other criteria can be used. The clusters of the partition (like the initial partition) can for example be determined to favor the grouping of the nodes which implement the same service in the communication network. They can also be created randomly.

Considering the communication cost between nodes of a cluster, either for the initialization or for the reorganization of the clusters, can help in a potential reduction of the communication cost. Indeed, if the nodes are grouped by geographical areas and the weight updates are only shared between the nodes of the same geographical area, the communication latency and the energy consumption will be reduced since they are increasing functions of the distance between the two nodes communicating the weights.

In addition, in some cases there may be a correlation between the non-IID distribution of the data and the geographic distribution of the devices.

In one particular embodiment of the invention, the weights of the model of a cluster can be obtained by aggregation of the weights of the models of the nodes that compose this cluster. The nodes communicate the weights (or as a variant the gradients) of their models, resulting from local calculations from their local datasets. Thus, the data remain local and are not shared or transferred, which ensures data privacy, while achieving the learning objective.

The invention is in this sense very different from the federated multi-task optimization method described in the document «V. Smith, C. K. Chiang, M. Sanjabi, and A. Talwalkar, “Federated multi-task learning,” Advances in Neural Information Processing Systems, vol. 2017-Decem, no. Nips, pp. 4425-4435, 2017 » which does not propose to group the nodes into clusters.

Different aggregation methods can be used to update the aggregate model of a cluster of level n from the aggregate models of the clusters of higher level n+1 or from the models of the nodes that compose this cluster of level n.

In one particular embodiment, the aggregation method used to update:
the weights of the aggregate models of the clusters; or
the weights of the overall model; or
the weights of the aggregate models of the reorganized clusters uses a weighted average or a median.

For example, the «Federated Average» method (average weighted by the size of the dataset of the nodes) presented in the document «H. Brendan McMahan, E. Moore, D. Ramage, S. Hampson, and B. Agüera y Arcas, “Communication-efficient learning of deep networks from decentralized data,” Proceedings of the 20th International Conference on Artificial Intelligence and Statistics, AISTATS 2017, vol. 54, 2017 » can be used.

For example, the Coordinate-wise median method presented in the document «D. Yin, Y. Chen, K. Ramchandran, and P. Bartlett, “Byzantine-robust distributed learning: Towards optimal statistical rates,” 35^{th}International Conference on Machine Learning, ICML 2018, vol. 13, p. 8947-8956, 2018» can also be used.

In one particular embodiment, the method includes a loop implemented within each cluster. At each iteration, the aggregate model of the cluster is communicated to each of the nodes of the cluster, each of the nodes of the cluster updates its model by performing for example a gradient descent with its local data and returns either its new model or the change or the update of its model (i.e. the weight difference between the current iteration and the previous iteration) so that it is aggregated at the level of the aggregate model of the cluster and returned to the nodes of the cluster in the next iteration. This loop may or may not include a constant number of iterations. For example, it can stop when a stopping condition is met.

In one embodiment of the invention, the coordination entity determines how the weights of the global model change, for example to what extent this global model continues to converge, and decides whether or not to redefine the clusters.

In one embodiment of the invention, this determination can comprise obtaining a representation of the overall model in the form of a vector whose coordinates are constituted by the changes in the weights of this model and the decision to whether or not to redefine the clusters can take into account the norm of this vector, for example via a comparison of the norm of this vector with a constant value.

In one particular embodiment, the reorganization of the clusters is a reorganization of the set of nodes into a new partition of clusters of nodes. Optionally, new aggregation nodes can be defined for at least some of the clusters. These can be, for example, nodes of these reorganized clusters.

As a variant, other reorganizations could be envisaged, for example only for the nodes of some clusters.

In one embodiment, during this reorganization, the reorganized clusters are constituted according to a function taking into account:
a communication cost between the nodes within a reorganized cluster; and
a similarity of a change in the weights of the models of the nodes within a reorganized cluster.

For example, it may be sought to limit or minimize at least one of the elements above or a combination of these elements.

The fact of taking into account the similarity of the change in the weights of the models of the nodes to constitute the clusters of nodes can help group nodes which a priori have similarities in their local datasets, without sharing information on these local datasets. Such embodiments can help solve a problem of statistical heterogeneity. Indeed, by constituting clusters which group nodes having similar data distributions, statistical heterogeneity is greatly reduced within the clusters.

In one particular mode of implementation of the invention, this similarity is determined by:
asking said nodes to replace the weights of their models with the weights of the updated global model;
asking said nodes to update their model by training it with their local dataset; and by
determining a similarity of the changes in the weights of the models of the different nodes.

These requests can be made to the nodes directly by the coordination entity. As a variant, they can be carried out or relayed by the aggregation nodes.

In one particular embodiment, the changes in the weights of the models are represented in the form of vectors and the similarity of the changes in the weights of the models of the different nodes is for example determined by a method called cosine similarity.

In one particular mode of implementation of the invention, the weights of the updated global model are returned to each of the nodes, either directly or via the aggregation nodes of the clusters thus reorganized. The nodes can thus update their model with the global model. The aggregate models of the reorganized clusters can also be updated with the global model.

In one particular embodiment, these new clusters are then constituted by nodes selected according to a proximity criterion (communication cost for example) and whose models are likely to change in the same way.

It can be considered that these steps complete a general initialization phase and that a phase which can be referred to as “optimization phase” then begins, during which at least some of the clusters will be able to be reorganized, for example by creating subclusters or by excluding some of their nodes.

In one particular embodiment of the invention, this phase can include a loop implemented within each reorganized cluster, identical or similar for example to that of the initialization phase. At each iteration, the aggregate model of the reorganized cluster is communicated to each of the nodes of this cluster, each of the nodes updates its model by performing a gradient descent with its local dataset and returns either its new model or the change of its model so that it is aggregated at the level of the aggregate model of the reorganized cluster and returned to the nodes of this cluster at the next iteration. This loop can include a constant or variable number of iterations. For example, it can stop when a stopping condition is met.

In one particular embodiment, the learning method includes a step of determining whether at least one reorganized cluster must be restructured.

In one particular embodiment, it is determined whether a reorganized cluster must be restructured according to a convergence criterion which takes into account a change in the weights of said reorganized cluster and/or a change in the weights of the nodes of the reorganized cluster. For example, it may be a double convergence criterion taking into account a change in the weights of said reorganized cluster and a change in the weights of the nodes of the reorganized cluster.

In at least one embodiment of the invention, it is determined that a reorganized cluster must be restructured if the following conditions are met:
(1) the change in the weights of said reorganized cluster is lower than a threshold; and
(2) the weights of the model of at least one node of said reorganized cluster change strongly in a direction different from the direction in which the model of the reorganized cluster would change if it were deprived of said node.

In one embodiment of the invention, to verify the first criterion (1), the global model is represented in the form of a vector whose coordinates are constituted by the changes in the weights of this model and the norm of this vector is compared with a numerical value, used for example as a threshold value. This value can be a constant or a value which depends for example on the level of the cluster or on the number of iterations already carried out.

In one embodiment of the invention, to verify the second criterion (2), a similarity is determined between the change of each of the nodes of the cluster and the change that the cluster would have if it were deprived of this node. For example, for a given node:
the change in the weights of the model of this node by a first vector is represented;
a cluster identical to the cluster considered but deprived of this given node is temporarily constituted;
the change in the weights of the model of this temporary cluster by a second vector is represented; and
the similarity between these two vectors is calculated for example by the cosine similarity method.

In one particular embodiment, the restructuring of a cluster includes the grouping of at least part of the nodes of this cluster into at least one subcluster, these subclusters being constituted according to a function taking into account a communication cost between the nodes within one said subcluster and a similarity of a change in the weights of the models of the nodes within one said subcluster (to minimize this function for example).

This step is similar to the reorganization step described previously (initialization phase) except that it only applies to the nodes of the cluster to be restructured and not to all the nodes.

In one particular embodiment, if at least one node, called “isolated node”, of a cluster to be restructured is not allocated to a subcluster, this node can be allocated to another cluster.

To this end, in one embodiment, when the aggregation node of a cluster of level n detects an isolated node, it sends the identifier of this isolated node to an entity of the communication network so that this node is reallocated in another cluster.

This entity can for example be a coordination entity as mentioned below or a node which plays the role of aggregation in a cluster of level n−1.

In one particular embodiment of the invention, the reallocation of an isolated node to another cluster is carried out by the coordination entity mentioned above. Consequently, in one embodiment, the configuration method includes:
receiving, from the aggregation node of a first cluster, an identifier of an isolated node of said first cluster; and
reallocating this isolated node to another cluster, by taking into account proximity between:
   (i) a direction of the change in the weights of this isolated node when it is trained by local data to the isolated node; and
   (ii) a direction of the change in the weights of the aggregate model of this said other cluster compared to the same reference model.

In one particular embodiment, the methods mentioned above are implemented by a computer program.

Consequently, the invention also relates to a computer program on a recording medium, this program being likely to be implemented by a coordination entity or more generally in a computer. This program includes instructions adapted to the implementation of a configuration method or a learning method as described above. These programs can use any programming language, and be in the form of source code, object code, or intermediate code between source code and object code, such as in partially compiled form, or in any other desirable form.

The invention also relates to an information medium or a recording medium readable by a computer, and including instructions of a computer program as mentioned above.

The information or recording medium can be any entity or device capable of storing the programs. For example, the media can include a storage means, such as a ROM, for example a CD ROM or a microelectronic circuit ROM, or a magnetic recording means, for example a floppy disk or a hard drive, or a flash memory.

On the other hand, the information or recording medium may be a transmissible medium such as an electrical or optical signal, which can be conveyed via an electrical or optical cable, by radio link, by wireless optical link or by other means.

A program according to the invention can be particularly downloaded onto an Internet-type network.

Alternatively, the information or recording medium can be an integrated circuit in which a program is incorporated, the circuit being adapted to execute or to be used in the execution of one of the methods in accordance with the invention.

### BRIEF DESCRIPTION OF THE DRAWINGS:

Other characteristics and advantages of the present invention will emerge from the description given below, with reference to the appended drawings which illustrate exemplary embodiments devoid of any limitation. In the figures:

FIG. 1 represents, in a communication network, a set of nodes that can be used in at least one mode of implementation of the invention;

FIG. 2 schematically represents a node that can be used in at least one mode of implementation of the invention;

FIG. 3 represents clusters of nodes;

FIG. 4 represents clusters of nodes constituted on communication cost criteria;

FIG. 5 represents clusters of nodes constituted to group nodes whose local data have homogeneous distributions;

FIG. 6 represents a vector representation of the change of the model of a node;

FIG. 7 represents a cluster of the set of nodes in FIG. 1;

FIG. 8 illustrates the use of the vector representation of FIG. 6 on the cluster in FIG. 7;

FIG. 9 represents a cluster initialization phase that can be implemented in at least one embodiment of the invention;

FIG. 10 represents an optimization phase that can be implemented in at least one embodiment of the invention;

FIG. 11 represents the hardware architecture of a coordination entity in accordance with at least one embodiment;

FIG. 12 represents the functional architecture of a coordination entity in accordance with at least one embodiment;

FIG. 13 represents the hardware architecture of a node in accordance with at least one embodiment;

FIG. 14 represents the functional architecture of a node in accordance with at least one embodiment; and

FIG. 15 illustrates performances of the invention in one exemplary implementation.

### DESCRIPTION OF THE EMBODIMENTS

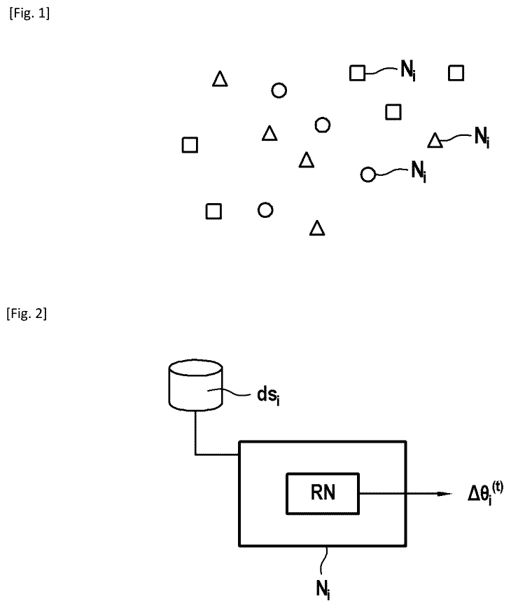

FIG. 1 represents a set of Nᵢ nodes in a geographical environment for example in a country, said nodes Nᵢbeing devices capable of communicating on a communication network.

In at least one embodiment, the nodes Ni each have access to a local dataset dsᵢ.

In at least one embodiment, if the set of nodes Nᵢ is considered, the data of the local datasets dsᵢ of these nodes are non-IID data.

In the example of FIG. 1, it is considered as an example that the local datasets dsᵢ, could follow three distributions. More specifically, it is assumed in this example that:
the data of the nodes represented in the form of a circle come from a first distribution of independent and identically distributed data;
the data of the nodes represented in the form of a square come from a second distribution of independent and identically distributed data; and that
the data of the nodes represented in the form of a triangle come from a third distribution of independent and identically distributed data.

In practice, the distribution of the local data dsᵢ, of a node Nᵢ is not known, this being moreover likely to vary over time as the node Nᵢ acquires or generates new data and/or as some data become obsolete.

Each node Nᵢ can acquire or generate the data dsᵢ, from its local dataset. These data dsᵢ, may for example be signaling or monitoring data of the communication network, for example quality of service data, statistics on the communication network, performance indicators of the communication network. It may also be data representative of the use of the node Nᵢ, for example durations, locations or ranges of use of the node Nᵢ, data on the profiles of the users of the node Nᵢ, data on the services accessed or offered by the node Nᵢ. It may also be data acquired by the node Nᵢ or by a sensor of the node Nᵢ, for example meteorological data, measurements of temperature, consumption, use, wear, etc. It may also be data entered or acquired by a user of the node Nᵢ, for example textual data (message contents, etc.), images, videos, voice messages, audio recordings, etc.

In at least one embodiment, the local data dsᵢ, of a node Nᵢ may be sensitive data in the sense that these data must not be shared or communicated to the other nodes. For example, it may be data private to a user of the node, such as personal data.

In some embodiments, a communication cost between two nodes Nᵢ, Nⱼ can be known. For example, the nodes are located, for example thanks to their GPS coordinates, and the communication cost between two nodes is constituted by the geographical distance between these nodes. In at least one other embodiment, the communication cost between two nodes can be a measurement of throughput, latency, bandwidth of a communication between these nodes.

FIG. 2 schematically represents a node Nᵢ. In at least one of the embodiments described here, a node Nᵢ includes a neural network NN which can be trained by a learning method from the local dataset dsᵢ, of this node.

In one embodiment of the invention, the structures (number and topology of the layers) of the models of the neural networks NN of the different nodes Nᵢ are identical. But the weights (or parameters) of the models of these networks are potentially different, since these networks are trained from different local datasets dsᵢ.

The training of a neural network of a node Nᵢ to obtain a more efficient model can comprise a few iterations (or rounds) of a gradient descent. More specifically, once the weights of the network have been initialized, during iteration, a node Nᵢ can perform a gradient descent during E epochs with different data (that is to say it calculates a gradient by using for example each of its local data dsᵢ, E times).
θθᵢθ^{t}Δθtθ^{t}−θ^{t-1}Δθᵢ^{t}=θᵢ^{t}−θᵢ^{t-1}=−η∇f(θᵢ^{t-1},dsᵢ)∇fη:E: B: In the remainder of the description we will note:
θθᵢθ^{t}Δθtθ^{t}−θ^{t-1}Δθᵢ^{t}=θᵢ^{t}−θᵢ^{t-1}=−η∇f(θᵢ^{t-1},dsᵢ)∇fη:E: B:: general notation to designate the weights (or parameters) of the model of a node
θθᵢθ^{t}Δθtθ^{t}−θ^{t-1}Δθᵢ^{t}=θᵢ^{t}−θᵢ^{t-1}=−η∇f(θᵢ^{t-1},dsᵢ)∇fη:E: B:: Current weights of the model of the node Nᵢ
θθᵢθ^{t}Δθtθ^{t}−θ^{t-1}Δθᵢ^{t}=θᵢ^{t}−θᵢ^{t-1}=−η∇f(θᵢ^{t-1},dsᵢ)∇fη:E: B:: Weight of a model at round t
θθᵢθ^{t}Δθtθ^{t}−θ^{t-1}Δθᵢ^{t}=θᵢ^{t}−θᵢ^{t-1}=−η∇f(θᵢ^{t-1},dsᵢ)∇fη:E: B: =: update of a model at round t
θθᵢθ^{t}Δθtθ^{t}−θ^{t-1}Δθᵢ^{t}=θᵢ^{t}−θᵢ^{t-1}=−η∇f(θᵢ^{t-1},dsᵢ)∇fη:E: B:: update of a model at round t locally calculated with the dataset dsᵢ, of the node Nᵢ
θθᵢθ^{t}Δθtθ^{t}−θ^{t-1}Δθᵢ^{t}=θᵢ^{t}−θᵢ^{t-1}=−η∇f(θᵢ^{t-1},dsᵢ)∇fη:E: B:: gradient of the cost function f
θθᵢθ^{t}Δθtθ^{t}−θ^{t-1}Δθᵢ^{t}=θᵢ^{t}−θᵢ^{t-1}=−η∇f(θᵢ^{t-1},dsᵢ)∇fη:E: B: learning rate
θθᵢθ^{t}Δθtθ^{t}−θ^{t-1}Δθᵢ^{t}=θᵢ^{t}−θᵢ^{t-1}=−η∇f(θᵢ^{t-1},dsᵢ)∇fη:E: B: number of epochs
θθᵢθ^{t}Δθtθ^{t}−θ^{t-1}Δθᵢ^{t}=θᵢ^{t}−θᵢ^{t-1}=−η∇f(θᵢ^{t-1},dsᵢ)∇fη:E: B: size of the data batch (retrieved randomly for example).

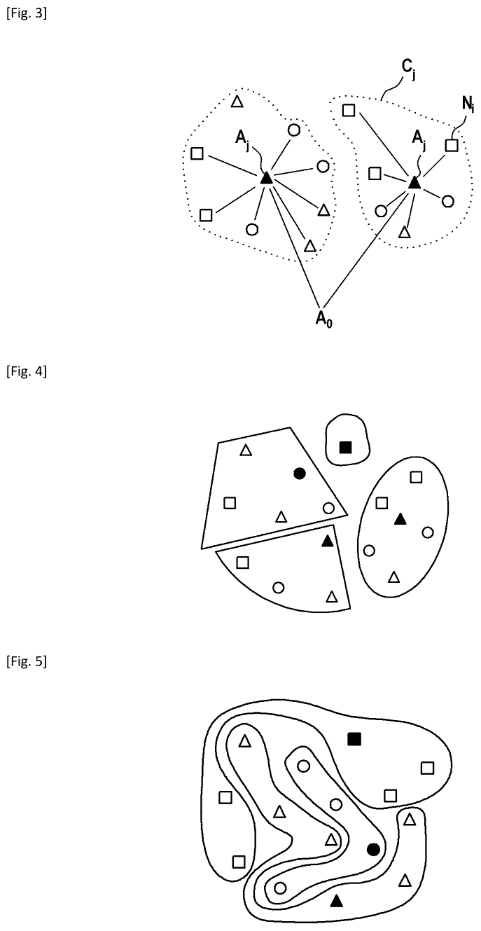

In at least one embodiment of the invention, and as represented in FIG. 3, the nodes Nᵢ are organized into groups or clusters Cⱼ.

In at least one of the embodiments described here, in each cluster Cⱼ, one of the nodes Nᵢ represented in black is an aggregation node Aⱼ of the cluster Cⱼ. In at least one of the embodiments described here, the nodes Nᵢ within a cluster Cⱼ communicate only via the aggregation node Aⱼ so that the communication cost between two nodes within a cluster is the sum of the communication costs between each of these nodes and the aggregation node Aⱼ of this cluster.

The number of cluster levels can be any number, each aggregation node of level n greater than or equal to 1being configured to communicate with an aggregation node of lower level n−1 with the convention introduced above.

In at least one of the embodiments described here, and for the sake of simplification, only two aggregation levels (levels 0 and 1) will be considered and the lowest level, level 0, is constituted by an aggregation node A₀(coordination entity within the meaning of the invention).

FIG. 3 represents the nodes of FIG. 1 grouped into two clusters Cⱼ of level 1, the aggregation nodes Aⱼ of these clusters being configured to communicate with the aggregation node A₀ of level 0. The dotted lines represent the clusters and the solid lines represent the communications between the nodes.

In at least one of the embodiments described here, the aggregation node A₀ of level 0 is able to communicate directly with each of the nodes Nⱼ but so as not to overload FIG. 3, these direct communications are not represented.

In at least one of the embodiments described here, each aggregation node Aⱼ is configured to constitute an aggregate model for the cluster Cⱼ from the local models of the nodes Nⱼ of this cluster.

In the same way, each aggregation node of level n, n greater than or equal to 0, is configured to constitute an aggregate model of level n from the aggregate models of the clusters of level n+1.
θⱼ: θⱼ^{t}: Δθⱼ^{t}:=θⱼ^{t}−θⱼ^{t-1} We will note:
θⱼ: θⱼ^{t}: Δθⱼ^{t}:=θⱼ^{t}−θⱼ^{t-1} Current weights of the model of the cluster Cⱼ
θⱼ: θⱼ^{t}: Δθⱼ^{t}:=θⱼ^{t}−θⱼ^{t-1} Model of the cluster Cⱼ obtained by aggregation of the models of all the nodes Nᵢ of the cluster Cⱼ
θⱼ: θⱼ^{t}: Δθⱼ^{t}:=θⱼ^{t}−θⱼ^{t-1} : Update of the model of the cluster Cⱼ at round t.

Generally, and as described specifically below, in at least one of the embodiments described here:
the aggregation node A₀ of level 0 is configured to constitute, optimize and reorganize the clusters Cⱼ and to designate an aggregation node Aⱼ within each of these clusters;
an aggregation node of level n is configured to be able to send the weights of a model to a node either directly or via a chain of aggregation nodes of intermediate levels between the level of the aggregation node and the level of this node;
the aggregation node Aⱼ of a cluster Cⱼ is configured to ask the nodes Ni of its cluster to update their models (for example by performing a gradient descent from their local datasets dsᵢ),
the nodes Nᵢ are configured to send to the aggregation node Aⱼ of their cluster Cⱼ the update Δθᵢ of their model;
an aggregation node of level n−1, n greater than or equal to 1, is configured to update its model from the updates of the models of the clusters of level n;
the aggregation node Aⱼ of a cluster Cⱼ is configured to restructure its cluster Cⱼ for example to group some nodes of this cluster into subclusters or to exclude some nodes from its cluster Cⱼ, for example if it determines that the change of the models of some nodes of its cluster does not follow that of its aggregate model or that of other nodes of its cluster.

In at least one embodiment of the invention, the clusters resulting from the partitions and the successive restructuring are constituted by pursuing a dual objective, namely:
limiting (e.g. minimizing) the communication costs between the nodes, and;
constituting clusters of nodes having local datasets with homogeneous distributions.

FIG. 4 represents a grouping of the nodes Nᵢ of FIG. 1 into four clusters that optimize the communication costs, the nodes Nᵢ being grouped on a purely geographical criterion (first criterion above).

FIG. 5 represents a grouping of the nodes Nᵢ of FIG. 1 into three clusters, the nodes of the same cluster having local datasets with homogeneous distributions, in order to take into account the second criterion (to optimize for example the second criterion).

The clusters determined by the invention may result, for example, from a compromise between these two organizations.

In at least one of the embodiments described here, the nodes Nᵢ do not communicate their local datasets dsᵢ, neither to the other nodes nor to the aggregation nodes nor to the coordination entity. In such an embodiment, the local datasets dsᵢ, therefore cannot be used directly to distribute the nodes in the clusters.

Consequently, the nodes Nᵢ whose updates Δθᵢ^{(t)} of their models change in the same direction can for example be grouped into clusters (or subclusters), by considering the updates Δθᵢ^{(t)} of the models as representative of the distributions of the datasets based on which these models were trained, and that aggregating models that change in the same direction can help obtain an aggregate model that will change in this same direction.

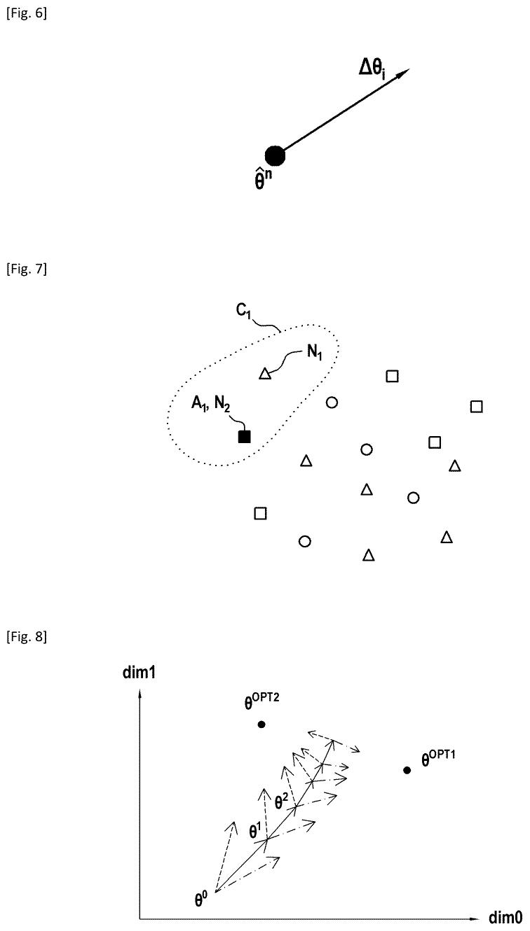

Δθᵢ\hat{θ}ⁿ In one particular embodiment, and as represented in FIG. 6, the change of the model of a node Nᵢ can be represented in the form of a vector whose:

Δθᵢ\hat{θ}ⁿ-origin represents the weights of the model before its change, in other words a reference model;
norm of this vector is representative of the importance of the change in the model: the greater the norm, the more the model changes; and
direction of this vector represents the way in which the model changes: if the model converges towards an optimal model for this node, the direction of this vector is directed towards this optimal model. Considering that the models of the nodes trained on datasets having neighboring distributions change in neighboring directions, it can be considered that the direction of this vector indirectly represents the distribution of the local dataset based on which the model has been trained.

This will now be illustrated with reference to FIGS. 7 and 8.

With reference to FIG. 7, a cluster C₁ including two nodes N₁, N₂ is considered, the node N₂ being the aggregation node A₁ of this cluster. The nodes N₁, N₂ have local datasets ds₁, ds₂ coming from different distributions.

FIG. 8 represents for example the weights θ^{OPT1} of the model considered optimal of the dataset ds₁ and the weights θ^{OPT2} of the model considered optimal of the dataset ds₂. These weights are unknown. For the sake of simplification, it is considered in this figure that the weights θ are of dimension 2, dim0 and dim1.

It is assumed that the models of the nodes N₁ and N₂ are initialized with the same set of weights θ⁰.

The phantom vectors represent, at each round t, the change of the model of the node N₁. It is seen that the norms of these vectors tend (if the model converges) to decrease at each round t, and that these vectors are (normally) directed towards the point representing the weights θ^{OPT1} of the optimal model of the dataset ds₁.

The dotted line vectors represent, at each round t, the change in the model of the node N₂. It is seen that the norms of these vectors tend (if the model converges) to decrease at each round t, and that these vectors are (normally) directed towards the point representing the weights θ^{OPT2} of the optimal model of the dataset ds₂.

The solid line vectors represent the change in the aggregate model of the cluster C₁, obtained by aggregation of the models of the nodes N₁ and N₂.

It is noticed that over the rounds (for example at each round), if the models converge:
(1) the norm of the solid line vectors decreases because the aggregate model changes less and less;
(2) the angle between the vector representing the change of the model of the node N₁ and the vector representing the change of the model of the node N₂ increases, each of these models gradually departing from the shared initial model θ⁰; and
(3) the angle between the vector representing the change in the model of the node N₁ (or N₂) and the solid line vector representing the change in the model of the cluster C₁ increases.

These findings can help determine that the aggregate model is no longer changing.

In this FIG. 8, only one node for each of the distributions is considered. But those skilled in the art will understand that if the cluster C₁ had comprised k nodes with local datasets similar to ds₁ (respectively ds₂), each of the vectors associated with these k nodes could have, over the rounds, changed in an identical manner to the vectors in dotted lines (respectively in mixed lines).

In one particular mode of implementation of the invention, and as detailed later, once the aggregate model no longer changes, the nodes whose changes of the models are represented by vectors of identical or neighboring directions are intended to be grouped in the same cluster (assuming that this grouping is not questioned by the criterion of limitation of the communication costs).

Modes of implementation of a configuration method and of a learning method in accordance with the invention will now be described. These methods are described in the context of a system in accordance with the invention and including a coordination entity A₀ and a set of nodes Nᵢ all able to play the role of aggregation node within a cluster and the role of worker node.

In the exemplary embodiment described here, the coordination entity A₀ can be considered as an aggregation node of level 0.

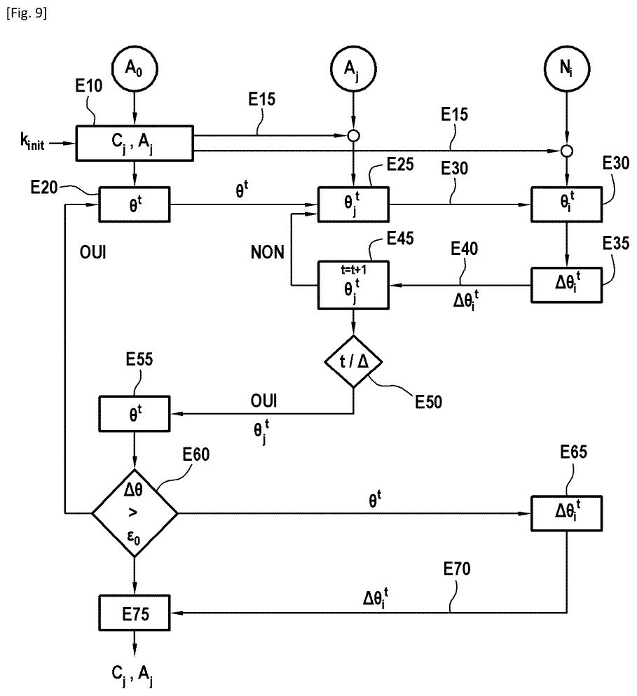

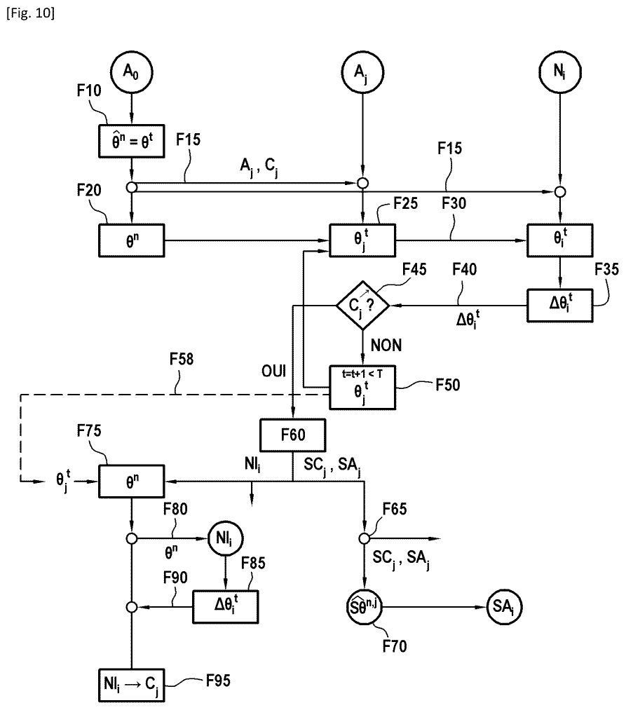

In this example, a cluster initialization phase with reference to FIG. 9 and an optimization phase with reference to FIG. 10 are described.

With reference to FIG. 9, in at least one of the embodiments described here, the cluster initialization phase includes steps E10 to E75.

During a step E10, the aggregation node A₀ of level 0 (coordination entity within the meaning of the invention) performs a first partition of the nodes Nᵢ to initialize the clusters Cⱼ and determines, among the nodes Nᵢ, the aggregation node Aⱼ of each of these clusters Cⱼ. In at least one of the embodiments described here, the method includes a parameter kinit which defines the number of clusters which must be created during this initial partition.

In at least one of the embodiments described here, during this initialization step, the clusters kinit are constituted only by taking into account the distances between the nodes Ni, based on their geographical locations.

In some embodiments, the constitution of the clusters can for example comprise the creation of a cluster per node Nᵢ and recursive mergings of pairs of clusters closest to each other into a single cluster.

In some embodiments, the constitution of the clusters can for example use the Hierarchical Agglomerative Clustering algorithm presented in the document «T. Hastie, R. Tibshirani, and J. Friedma, The Elements of Statistical Learning, second edi ed. Springer, 2008 ».

For each of the clusters Cⱼ (j=0, . . . kinit−1) thus created, the aggregation node Aⱼ can be chosen for example as the node Nᵢ of this cluster which minimizes the sum of the distances between this node Aⱼ and each of the other nodes of this cluster.

In one embodiment, during a step E15, once the clusters Cⱼ have been created, the coordination entity A₀sends:
to each node Aⱼ intended to become an aggregation node, information according to which this node Aⱼmust play the role of aggregation node in a cluster Cⱼ and the identifiers of the nodes Nᵢ of this cluster Cⱼ; and
to each node Nᵢ, the identifier of the aggregation node Aⱼ of the cluster Cⱼ to which it belongs. so that for a given cluster, the nodes Nⱼ and the aggregation node Aⱼ of this cluster can be configured to communicate with each other.

In at least one of the embodiments described here, at the first occurrence of a step E20, the coordination entity A₀ initializes a variable t representing the number of the current round to 0 and sends, to each aggregation node Aⱼ, the weights θ₀ of an initial global model to the set of nodes and a request to learn the models of the nodes of this cluster with these weights.

In at least one of the embodiments described here, the learning request can be accompanied by a number δ of updates, in other words by iterations to be carried out for this learning.

In at least one of the embodiments described here, during a step E25, the aggregation node Aⱼ of each of the clusters Cⱼ initializes the weights of its model θⱼ^{t} for round t with the weights θ^{t} of the global model.

In at least one of the embodiments described here, during a step E30, the aggregation node Aⱼ of each of the clusters Cⱼ sends the weights θⱼ^{t} of its aggregate model to each of the nodes Nⱼ of its cluster.

In at least one of the embodiments described here, during a step E35, each of the nodes Nᵢ initializes the weights of its local model θⱼ^{t} for round t with the weights θⱼ^{t} of the model of its cluster Cⱼ.

In at least one of the embodiments described here, during step E30 already described, when the aggregation node Aⱼ sends the weights θⱼ^{t} of the model of its cluster to a node Nᵢ, it asks it to update its model θⱼ^{t} . In one embodiment, the aggregation node Aⱼ communicates the hyperparameters E, B, η to the nodes Nᵢ.

In at least one of the embodiments described here, during a step E35, the node Nᵢ updates its model θⱼ^{t} . For example, it performs a gradient descent during E epochs on a batch of size B of its local data dsᵢ.

In at least one of the embodiments described here, during a step E40, the node Nᵢ sends the update Δθⱼ^{t} of its model for round t to the aggregation node of its cluster Cⱼ.

In at least one of the embodiments described here, during a step E45, an aggregation node Aⱼ increments the variable t (number of the current round) and updates the weights of the aggregate model θⱼ^{t} of its cluster Cⱼfor the round t by aggregation of the updates Δθⱼ^{t} of the weights of the models of the nodes Nᵢ of this cluster Cⱼthat are received in step E40. It is noted here that the variables t of θⱼ^{t} and of Δθⱼ^{t} differ by one unit, since for example, the weights of the model θⱼ^{t} of the cluster Cⱼ for round 1 are obtained by aggregation of the updates Δθⱼ^{t} of the models of the nodes Nᵢ at round 0.

Different aggregation methods can be used, for example the methods such as «Federated Average» (average weighted by the size of the dataset dsᵢ, of the node Nᵢ) or «Coordinate-wise median» known to those skilled in the art.

In at least one of the embodiments described here, during a step E50, an aggregation node Aⱼ verifies whether the rounds δ (or iterations) have been carried out, in other words whether t is divisible by δ. If this is not the case, the result of test E50 is negative and the aggregation node sends (during a new iteration of step E30), the weights θⱼ^{t} of the model of its updated cluster Cⱼ to each of the nodes Nᵢ of its cluster. These update their model θⱼ^{t} (step E35) and send the update Δθⱼ^{t} to the aggregation node Aⱼ (step E40) so that it increments the value t and updates the aggregate model θⱼ^{t} of its cluster Cⱼ (step E45).

In at least one of the embodiments described here, when the rounds δ (or iterations) have been carried out, the result of the test E50 is positive and the aggregation node Aⱼ sends the aggregate model θⱼ^{t} of its cluster Cⱼto a node playing the role of aggregation node in a cluster of lower level, namely, in this example, to the coordination entity A₀.

In at least one of the embodiments described here, during a step E55, the coordination entity A₀ updates the weights of the global model θ^{t} by aggregation of the aggregate models θⱼ^{t} of the clusters Cⱼ. The coordination entity A₀ can use different aggregation methods according to the embodiments, and for example the aforementioned «Federated Average» or «Coordinate-wise median» aggregation methods.

In at least one of the embodiments described here, during an test E60, the coordination entity A₀ determines whether the global model θ^{t} is still far from the convergence or not. To do so, it compares the norm of the change Δθ^{t} of its model (Δθ^{t} θ^{t}−θ^{t-1}) with a convergence criterion ε₀.

In at least one of the embodiments described here, when the norm of the change Δθ^{t} of its model is greater than the convergence criterion ε₀, the coordination entity A₀ considers that its model continues to converge and the result of the test E60 is positive. It then sends (new occurrence of step E20) the weights θ^{t} of the new global model to the aggregation nodes Aⱼ of the clusters Cⱼ, asking them to repeat the process described above to update δ times their aggregate models θⱼ^{t} .

In at least one of the embodiments described here, when the norm of change Δθ^{t} of its model is lower than the convergence criterion ε₀, the coordination entity A₀ considers that its model is no longer changing and the result of the test E60 is negative.

In at least one of the embodiments described here, it then sends, during a step E65, the weights θ^{t} of the global model to the nodes Nᵢ (either directly or via the aggregation nodes Aⱼ of the clusters Cⱼ) and asks them to update this model θᵢ^{t} .

In at least one of the embodiments described here, the nodes Nᵢ update their model θᵢ^{t} during a step E65 (for example by performing a gradient descent from their local dataset dsᵢ) and send the update Δθᵢ^{t} of their models to the coordination entity A₀ during a step E70.

In at least one of the embodiments described here, during a step E75, the coordination entity A₀ carries out a new partition of the nodes to reorganize the clusters. It is recalled that in step E10, the clusters kinit had been constituted, in the embodiment cited as an example, by only taking into account the distances between the nodes Nᵢ, based on their geographical locations.

However, at this stage, the global model created based on these first clusters, on a purely geographical criterion, no longer changes or barely changes.

In at least one of the embodiments described here, and as mentioned previously, step E75 reorganizes the nodes into clusters so that they address a compromise, namely limiting (for example minimizing) the communication costs between the nodes within a cluster, and on the other hand constituting clusters of nodes whose updates Δθᵢ^{(t)} of their models change in the same direction, this second criterion representing a priori the fact that these nodes have local datasets coming from homogeneous distributions.

In at least one of the embodiments described here, step E75 reorganizes the clusters to globally optimize the dimension d_{i,k} calculated for each pair of nodes Nᵢ, Nₖ:

$${d}_{i , k} ← {α}_{i , k} + β {min}_{a ∈ A} [ {( {( {x}_{i} - {x}_{a} )}^{2} + {( {y}_{i} - {y}_{a} )}^{2} )}^{\frac{α}{2}} + {( {( {x}_{k} - {x}_{a} )}^{2} + {( {y}_{k} - {y}_{a} )}^{2} )}^{\frac{α}{2}} ]$$

Δθᵢ^{(t)}Δθₖ^{(t)} in which:
Δθᵢ^{(t)}Δθₖ^{(t)}−□□_{i,k} is a distance between the updates and of the models of the nodes Nᵢ and Nₖ;
(xᵢ, yᵢ) designates the geographic coordinates of the node Nᵢ. It is noted that in this embodiment of the invention, it is considered that the communications between two nodes Nᵢ, Nₖ pass through an aggregation node a
□ designates the relative importance of the communication cost in the function to be minimized relative to the di-similarity of the updates); and
□ designates the pass-loss exponent).

In one embodiment of the invention,

$${α}_{i , k} ← 1 - \frac{〈 Δ {θ}_{k} , {Δθ}_{i} 〉}{‖ {Δθ}_{k} k ‖ ‖ {Δθ}_{i} ‖}$$

where <x, y>denotes the scalar product of x and y and ∥x∥ denotes the norm of x.

At the end of step E75, the new clusters Cⱼ are reorganized and their aggregation nodes Aⱼ are designated.

It can be considered, at least in some embodiments, that this step E75 completes an initialization phase.

It can be considered that this initialization phase is followed by an optimization phase which will now be described with reference to the FIG. 10.

In at least one of the embodiments described here, this optimization phase includes steps F10 to F95.

During a step F10, the coordination entity A₀ records the global model θ^{t} as a reference model \hat{θ}ⁿ.

In at least one embodiment, during a step F15, in a manner similar to step E15 already described, the coordination entity A₀ sends:
to each node Aⱼ intended to become an aggregation node in this new partition, information according to which this node Aⱼ must play the role of aggregation node in a cluster Cⱼ and the identifiers of the nodes Nᵢ of this cluster Cⱼ; and
at each node Nᵢ, the identifier of the aggregation node Aⱼ of the cluster Cⱼ to which it belongs. so that for a given cluster, the nodes Nᵢ and the aggregation node Aⱼ of this cluster can be configured to communicate with each other.

θ^{t} In at least one of the embodiments described here, during a step F20, the coordination entity A₀ sends to each aggregation node Aⱼ:
θ^{t}—the weights of the global model; and
a request to learn the weights θᵢ of the models of the nodes Nⱼ of this cluster Cⱼ with the weights θ^{t} of the global model.

In at least one of the embodiments described here, during a step F25, the aggregation node Aⱼ of each of the reorganized clusters Cⱼ initializes the weights of its model Δθⱼ^{t} of for round t with the weights θ^{t} of the global model.

In at least one of the embodiments described here, during a step F30, the aggregation node Aⱼ of each of the reorganized clusters Cⱼ sends the weights θⱼ^{t} of its aggregate model to each of the nodes Nᵢ of its cluster and their request to update their model θᵢ^{t} by performing a gradient descent from their local dataset dsᵢ.

In at least one of the embodiments described here, during a step F35, each of the nodes Nᵢ initializes the weights of its local model θᵢ^{t} for round t with the weights θⱼ^{t} of the model of its cluster Cⱼ and updates this model by performing a gradient descent during E epochs on a batch of size B of its local data dsᵢ.

In at least one of the embodiments described here, during a step F40, the node Nᵢ sends the update Δθᵢ^{t} of its model for round t to the aggregation node of its cluster Cⱼ.

Δθᵢ^{t}θⱼ^{t} of In at least one of the embodiments described here, during a test F45, the aggregation node Aⱼ of a reorganized cluster Cⱼ determines whether the cluster Cⱼ must be restructured. In the example described here, and as described previously with reference to FIG. 8, this step amounts to:

Δθᵢ^{t}θⱼ^{t} calculating for each node Nᵢ of the cluster Cⱼ a vector representative of the change of the model of this node for round t. This vector has as origin a point representing, and a direction substantially directed towards the weights of the optimal model of the dataset dsᵢ of this node Nᵢ;
calculating the norm of the change of the aggregate model Δθⱼ^{t} of the cluster Cⱼ obtained from the updates Δθᵢ^{t} of the model of the nodes Nᵢ of the cluster Cⱼ received in step F40. This norm is for example in the example illustrated in FIG. 8 the norm of the vector represented in solid lines in FIG. 8;
determining whether this norm is greater than a convergence criterion εₙ. If so, the aggregation node Aⱼ of the cluster Cⱼ determines that the model of the cluster Cⱼ continues to converge and that it is not yet necessary to modify the cluster Cⱼ.

Still during this test F45, if the norm of the aggregate model Δθⱼ^{t} of the cluster Cⱼ is lower than the convergence criterion εₙ, which is the case if the model of the cluster Cⱼ no longer converges, the aggregation node Aⱼ determines whether there is at least one model of a node Nᵢ of its cluster which continues to change differently from the models of the other nodes of the cluster.

In at least one of the embodiments described here, to determine whether the model of a node Nᵢ continues to change, an aggregation node Aⱼ compares the norm of Δθⱼ^{t} with the convergence criterion εₙn.

Δθᵢ^{t} In at least one embodiment, to determine whether the model of a node Nᵢ which continues to change, changes differently than the models of the other nodes of the cluster Cⱼ the aggregation node Aⱼ considers the angle between:
Δθᵢ^{t} the vector representing the update of the model of this node; and
a vector representing the change that the model of the cluster Cⱼ would have without this node Nᵢ. (Those skilled in the art will understand that this vector is not exactly the vector represented in solid lines in FIG. 8, because in this figure it represents the change of the cluster Cⱼ in full).

More specifically, in at least one of the embodiments described here, the aggregation node Aⱼ considers that the model of a node of the cluster changes differently if αₜ>□ where:

$${α}_{i} ← 1 - \frac{〈 Δθ , {Δθ}_{i} 〉}{‖ Δθ ‖ ‖ {Δθ}_{i} ‖}$$

If this is not the case, in other words, if the model of the cluster Cⱼ continues to change, without any model of the node Nᵢ changing in a direction significantly different from that in which the model of the cluster would change without this node, the result of the test F45 is negative.

In this case, in at least one of the embodiments described here, the aggregation node Aⱼ of a cluster Cⱼcalculates during a step F50, the aggregate model θⱼ^{t} of the cluster Cⱼ obtained from the updates Δθᵢ^{t} of the model of the nodes Nᵢ of the cluster Cⱼ received in step F40. This updated model is sent to all the nodes Nᵢ of the cluster Cⱼ during a new iteration of step F30.

In at least one of the embodiments described here, the loop of steps F25 to F50 is carried out as long as t is smaller than a value T. Other stopping criteria can be used.

In at least one of the embodiments described here, the aggregation node Aⱼ sends (step F58) the aggregate model θⱼ^{t} of its cluster Cⱼ to the coordination entity A₀ (or to the aggregation node of lower level).

When an aggregation node Aⱼ determines either that the model of the cluster Cⱼ is no longer changing or that there is at least one node whose model is changing in a “bad” direction, the result of the test F45 is positive, and the aggregation node Aⱼ undertakes, during a step F60, a restructuring of the cluster Cⱼ.

This step is similar to step E75 already described except that it only applies to the nodes of the cluster Cⱼand not to all the nodes. It therefore produces a set of subclusters of the cluster SCⱼ and aggregation nodes SAⱼof these subclusters, these subclusters SCⱼ being constituted to limit the communication costs between their nodes and to group together nodes whose updates of their models change substantially in the same direction. Possibly, nodes Nᵢ, are not assigned to any of the subclusters and can be considered isolated.

In at least one of the embodiments described here, the subclusters SCⱼ and the isolated nodes Nᵢ, are not processed in the same way.

In one embodiment, during a step F65, the aggregation node Aⱼ sends:
to each node SAⱼ intended to become an aggregation node in a subcluster SCᵢ, information according to which this node SAⱼ must play the role of aggregation node in the cluster SCⱼ and the identifiers of the nodes Nᵢ of this subcluster SCᵢ; and
to each node Nᵢ of this subcluster SCⱼ, the identifier of the aggregation node SAⱼ of this subcluster SCⱼ to which it belongs
   so that the nodes Nᵢ and the aggregation node SAⱼ of this subcluster can be configured to communicate with each other.

θⱼ^{t} In at least one of the embodiments described here, during this step F65, the aggregation node Aⱼ sends to each aggregation node SA:
θⱼ^{t}the weights of its aggregate model; and
a request to learn the weights θᵢ of the models of the nodes Nᵢ of this cluster Cⱼ with the weights θⱼ^{t} of this aggregate model.

In at least one of the embodiments described here, an aggregation node Aⱼ creates, during a step F70, for each subcluster, a reference model [symbol] by aggregation of the models of the nodes of this subcluster and then sends the weights of this model to the aggregation node SAⱼ of this subcluster SCⱼ. This subcluster aggregation node can then recursively implement the steps described above to customize its subcluster.

In at least one of the embodiments described here, when a node NIᵢ is isolated, the aggregation node of lower level, namely the coordination entity A₀ in this example, updates, during a step F75, the reference model \hat{θ}ⁿ by aggregation of the models θᵢ^{(t)}.

In at least one of the embodiments described here, the coordination entity A₀ sends the weights of this reference model to the isolated node NIᵢ during a step F80.

In at least one of the embodiments described here, during a step F85, the isolated node NIᵢ initializes the weights of its local model with the weights of this reference model \hat{θ}ⁿ and updates this model by performing a gradient descent. The isolated node NIᵢ sends the update of its model to the coordination entity A₀ during a step F90.

In at least one of the embodiments described here, during a step F95, the isolated node NIᵢ is allocated to the cluster Cⱼ whose change of the model compared to the reference model \hat{θ}ⁿ , i.e. (θᵢ^{(t)}−\hat{θ}ⁿ), closest to Δθᵢ.

In the previous example, a mode of implementation of the invention for a system including only two aggregation levels is described but the invention can be implemented with a greater number of aggregation levels.

Generally, during the initialization phase, when an aggregation node Aⱼ has updated the aggregate model θⱼ^{t} of its cluster Cⱼ (step E45), it sends it to the aggregation node of lower level so that it can update its own model (step E55) by aggregation of the models it receives. Generally, an aggregation node of level n is configured to determine (step E60) whether its aggregate model is still far from the convergence by comparing the norm of the change of its model with a convergence criterion εₙ which can be specific to this aggregation level.

At the end of the initialization phase, an aggregation node of level n sends a reference model resulting from this initialization phase to the aggregation nodes of level n+1 (step F10). Each aggregation node is configured to determine whether its cluster must be reconfigured (step F45) and if so, to create subclusters (step F60) or ask the aggregation node of lower level to assign a cluster (step F95) to the nodes that would be isolated.

With reference to FIG. 11, in at least one of the embodiments described here, the coordination entity A₀ has the hardware architecture of a computer. It comprises in particular a processor 11, a read only memory 12, a random access memory 13, a non-volatile memory 14 and communication means 15.

These communication means 15 can in particular allow the coordination entity A₀ to communicate with nodes of the network.

The read only memory 12 of the coordination entity A₀ constitutes a recording medium in accordance with the invention, readable by the processor and on which a computer program PGC in accordance with the invention is recorded, including instructions for the execution of a weight configuration method according to the invention.

For example the processor of said coordination entity (A₀) can be capable of:
at least one partition of the set of nodes (Nᵢ) into at least one cluster of nodes;
a designation of at least one node (Aᵢ) of said cluster for a role of aggregation node managing an aggregate model of said at least one cluster of nodes for said federated learning, said designation comprising sending, to the nodes (Nᵢ) of said cluster, information designating said node (Aⱼ) as an aggregation node and sending, to the node (Aᵢ), identifiers of the nodes (Nᵢ) of said cluster.

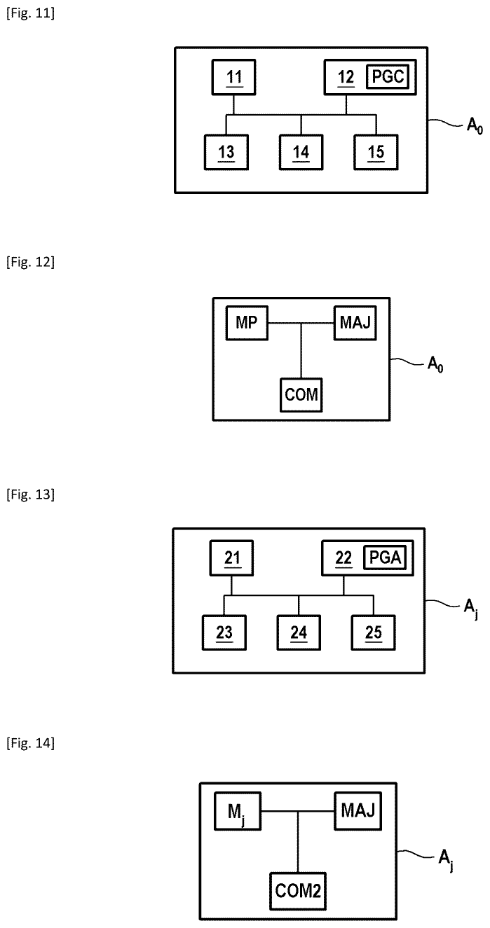

The program PGC defines various functional and software modules of the coordination entity A₀, able to implement the steps of the weight configuration method. With reference to FIG. 12, In one particular embodiment, these modules comprise in particular here:
a partitioning module MP configured to partition a set of nodes Nᵢ into at least one cluster Cⱼ;
a communication module COM configured to send to a node Aⱼ belonging to at least one cluster Cⱼ, called aggregation node Aⱼ, information according to which said node Aⱼ must play the role of an aggregation node Aⱼ in this cluster Cⱼ of nodes and identifiers of the nodes Nᵢ of this cluster Cⱼ;
the module COM being configured to send, to at least one aggregation node Aⱼ, a request to learn the weights θᵢ of models of the nodes Nᵢ of this cluster Cⱼ with the weights of a global model to the set of nodes;
the module COM being configured to receive, from said at least one aggregation node Aⱼ, weights of the aggregate model of the cluster Cⱼ resulting from this learning; and
a module MAJ for updating the weights of said global model by aggregation of the received weights of the aggregate model of said at least one cluster.

FIG. 13 represents, in one embodiment of the invention, the hardware architecture of a node Aⱼ able to play the role of aggregation node in a cluster of nodes from a set of nodes, neural networks of the nodes of this set all having the same structure. This node Aⱼ comprises in particular a processor 21, a read only memory 22, a random access memory 23, a non-volatile memory 24 and communication means 25. These communication means 25 can in particular allow the node Nᵢ to communicate with a coordination entity A₀ or with other nodes of the network, in particular within the same cluster.

The read only memory 22 of the node Aⱼ constitutes a recording medium in accordance with the invention, readable by the processor and on which a learning program PGA in accordance with the invention is recorded, including instructions for the execution of a learning method according to the invention.

For example, the processor of the node can be able to receive, from an entity of said communication network, before federated learning, weights of said models of the neural networks of the nodes from said set, in which said nodes locally train their models of neural networks and share the weights of their models with other nodes of said network of information designating a node (Aⱼ) of said set as an aggregation node managing an aggregate model for said federated learning and, when said node is said node, identifiers of the nodes of said cluster of a cluster whose said aggregation node manages said abbreviated model.

The program PGA defines various functional and software modules of the node Aⱼ able to implement the steps of the learning method. With reference to FIG. 14, in one particular embodiment, these modules comprise in particular here:
a communication module COM2 configured to receive, from an entity of the communication network:
information according to which the node Aⱼ must play the role of aggregation node in a cluster Cⱼ of nodes; and
identifiers of the nodes Nᵢ of the cluster Cⱼ;
the communication module COM2 being configured to receive, from an entity of the network, a request to learn the weights of the cluster from the weights of a model having said structure;
an initialization module MIN configured, in case of receipt of said learning request, to initialize weights θⱼ of an aggregate model Mⱼ of the cluster Cⱼ and weights θᵢ of the models of the nodes Nᵢ of the cluster Cⱼ with said received weights;
an update module MAJ configured to update weights of the aggregate model of the cluster Cⱼ, by aggregation of the weights of the models of the nodes Nᵢ of the cluster Cⱼ, trained with local datasets to these nodes, the weights of the models of the nodes of the cluster being replaced by the updated weights of the aggregate model of the cluster Cⱼ after each update;
the communication module COM2 being configured to send, to the entity of the network, weights of the aggregate model of said updated cluster.

In one embodiment in which this node, then noted Nᵢ, is also able to play the role of worker node, the communication means COM2 are configured to:
receive, from an entity of said communication network, an identifier of an aggregation node Aⱼ of a cluster Cⱼ to which the node Nᵢ belongs;
receive, from this aggregation node Aⱼ, weights of a model having said structure to initialize the weights of the model of the node Nᵢ;
transmit, to said aggregation node Aⱼ, weights of the model of the node Nᵢ trained with a local dataset to this node Nᵢ.

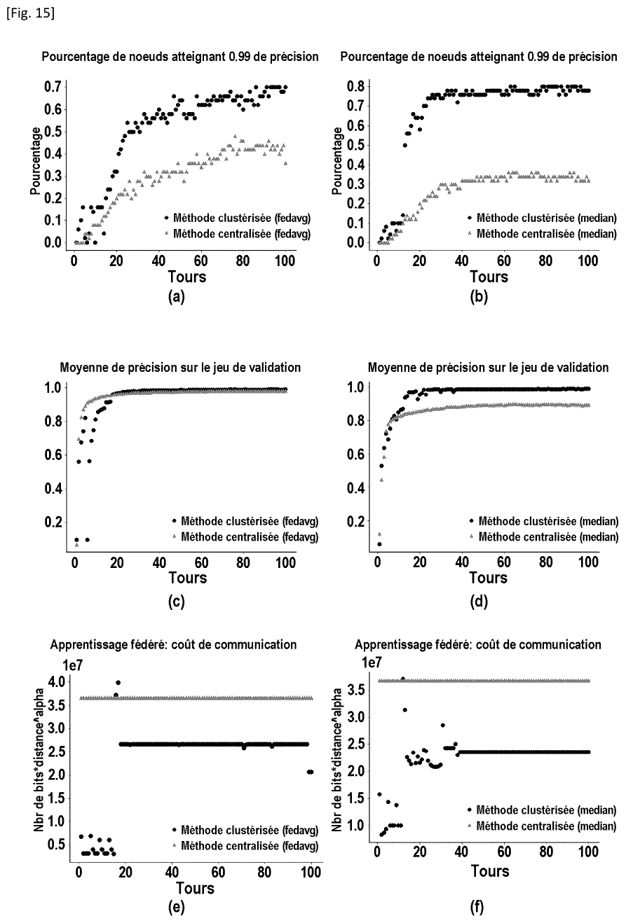

FIG. 15 illustrates performances of the invention in one exemplary implementation. More specifically:

The part (a) of FIG. 15 presents for 100 rounds t (represented on the abscissa), the percentage (on the ordinate) of nodes reaching 99% accuracy for two methods:
triangles: centralized federated learning of the state of the art in which the aggregation method uses a federated average;
rounds: federated learning by clusters in accordance with the invention in which the aggregation method uses a federated average.

The part (b) of FIG. 15 presents for 100 rounds t (represented on the abscissa), the percentage (on the ordinate) of nodes reaching 99% accuracy for two methods:
triangles: centralized federated learning of the state of the art in which the aggregation method uses a median;
rounds: federated learning by clusters in accordance with the invention in which the aggregation method uses a median.

In these examples, test images of the dataset MNIST which includes images each representing a number from 0 to 9, i.e. ten classes, are used. 99% accuracy means that for every 100 new known images, 99% are classified correctly.

This model is presented in the document «Y. LeCun and C. Cortes, “MNIST handwritten digit database,” 2010».

It appears in these parts (a) and (b) of FIG. 15, that for the two aggregation methods (federated and median average), the implementation of the invention (federated learning by clusters) presents a percentage of nodes reaching a 99% accuracy much higher than compared to a centralized federated learning algorithm.

The parts (c) and (d) of FIG. 15 respectively represent the weighted accuracy average by the number of examples in the validation set of the nodes for the two methods of the part (a) and for the two methods of the part (b) presented above.

In these figures, if a set of nodes that would only include two nodes is considered, the first node having a set of X1 local data and an accuracy P1 and the second node having a set of X2 local data and an accuracy P2, then the ordinate of a point would have as value:

$$( X 1 \cdot P 1 + X 2 \cdot P 2 / ( P 1 + P 2 ) .$$

The parts (e) and (f) of FIG. 15 respectively illustrate the interest of the invention in terms of reduction of communication costs in the case of an aggregation method of the federated average type and in the case of an aggregation method of the median type.

In these figures, a communication cost calculated in the case of a network of 50 nodes at each of the rounds is considered, the communication cost being in this example constituted by the sum of the communication costs (i) of the model towards the nodes and (ii) back from these nodes towards the aggregation nodes or towards the coordination entity, by taking into account the number of bits necessary to send the model (in other words the weights), multiplied by the sum of the distances between two nodes, to the power of □ (pass-loss exponent).

It is assumed here that in the case of centralized federated learning, the single aggregation node is the barycenter of all the nodes.

It is seen that the cluster federated learning can help reduce the communication cost by avoiding the communication between each node of the network and the single aggregation node.

Thus, it can be observed, for the two aggregation methods:
that, at the first round, the communication cost for the centralized federated model of the state of the art is more than 3.5 times higher than for the cluster federated model of the invention;
that, at the first rounds, the communication cost for the cluster federated model varies, due to the reorganization of the clusters;
that, after more than 20 rounds, the communication cost for the cluster federated model hardly varies, the clusters being stabilized, and is much lower than that of the centralized federated model. These results depend on the stability of the clusters and therefore on the parameters □□□□ and εₙ.

1. A method for configuring weights of models of neural networks of the same structure, of nodes from a set of nodes of a communication network, said method including a federated learning of said weights in which said nodes locally train their model of neural networks and share the weights of their model with other nodes of said communication network, the method including:
at least one partitioning of the set of nodes into at least one cluster of nodes;
designating at least a first node of said cluster as an aggregation node managing an aggregate model of said at least one cluster of nodes for said federated learning, said designation comprising:
sending, to the nodes of said cluster, information designating said first node as an aggregation node; and
sending, to the first node, the identifiers of the nodes of said cluster.

2. The method claim 1, wherein said designation is temporary, the method comprising another designation for at least one other partition of said set of nodes.

3. The method of claim 1, during said federated learning:
sending, to the aggregation node of said at least one cluster, a request to learn the weights of the models of the nodes of said cluster with the weights of a global model to the set of nodes;
receiving, from the aggregation node of said at least one cluster, the weights of said aggregate model of said cluster resulting from said learning; and
updating the weights of the global model by aggregation of the received weights of the aggregate model of said at least one cluster.

4. The method of claim 1, wherein the method comprises partitioning the set of nodes into at least one cluster by taking into account a communication cost between the nodes within said at least one cluster.

5. The method of claim 1, the method further comprising partitioning the set of nodes to reorganize said clusters into at least one reorganized cluster, said at least one reorganized cluster being constituted according to a function taking into account a communication cost between the nodes within a reorganized cluster and a similarity of a change in the weights of the models of the nodes within a reorganized cluster.

6. The method of claim 5, wherein said similarity is determined by:
asking said nodes to replace the weights of their model with the weights of the updated global model;
asking said nodes to update their model by training their model with their local dataset; and by
determining a similarity of the changes in the weights of the models of the different nodes.

7. The method of claim 1, the method further comprising:
receiving, from the aggregation node of a first cluster, an identifier of an isolated node of said first cluster; and
reallocating said isolated node to another cluster, by taking into account a proximity between:
a direction of a change of the weights of said isolated node when it is trained by local data to the isolated node; and
a direction of a change of the weights of the aggregate model of said other cluster, compared to the same reference model.

8. A learning method implemented by a node from a set of nodes including neural networks having a model of the same structure, of a communication network, said method including, before federated learning of the weights of said models of the neural networks of the nodes of said set, in which said nodes locally train their model of neural networks and share the weights of their model with aggregation nodes of said network:
receiving, from an entity of said communication network, information designating a first node from said set as an aggregation node managing an aggregate model for said federated learning and, when said node is said first node, identifiers of the nodes of a cluster whose said aggregation node manages said abbreviated model.

9. The method of claim 8, the method further comprising, when said node is said aggregation node;
receiving, from said entity of said communication network, the weights of a model having said structure;
upon receipt of a request to learn the weights of an aggregate model of said cluster from said received weights;
initializing the weights of the aggregate model of said cluster and the weights of the models of the nodes of said cluster with said received weights;
at least updating the weights of the aggregate model of said cluster, by aggregation of the weights of the models of the nodes of said cluster, trained with local datasets to these nodes, the weights of the models of the nodes of said cluster being replaced by the updated weights of the aggregate model of said cluster after each update; and
sending, to said entity of said network, the weights of the aggregate model of said updated cluster.

10. The method of claim 9, further comprising, when said node is said aggregation node;
determining whether said cluster must be restructured by taking into account a change in the weights of said cluster and/or a change in the weights of the nodes of said cluster.

11. The method of claim 8, further comprising, when said node is said aggregation node, in response to a determination that said cluster must be restructured, restructuring said cluster by grouping at least part of the nodes of said cluster into at least one subcluster, said at least one subcluster being constituted according to a function taking into account a communication cost between the nodes within said subcluster and a similarity of a change in the weights of the models of the nodes within one said subcluster.

12. The method of claim 11, wherein restructuring of said cluster includes sending, to said entity of said communication network, the identifier of an isolated node of said cluster.

13. The method of claims 8, further comprising, when said node is not said aggregation node:
receiving, from said aggregation node, the weights of a model having said structure to initialize the weights of the model of the node;
transmitting, to said aggregation node, the weights of the model of the trained node with a local dataset to said node.

14. The method of claim 8, said method being implemented by a node belonging to a first cluster, wherein said entity of said communication network is:
a coordination entity of the network; or
a node of said set of nodes playing the role of aggregation node managing an aggregate model of a second cluster of lower level than the level of said first cluster.

15. A coordination entity able to configure weights of models of neural networks of the same structure, of nodes from a set of nodes of a communication network, by federated learning of said weights in which said nodes locally train their models of neural networks and share the weights of their model with other nodes of said network, said coordination entity comprising at least one processor configured to implement the method of claim 1.

16. The coordination entity of claim 15, the coordination entity comprising:
a module for sending, to said aggregation node of said at least one cluster, a request to learn the weights of the models of the nodes of said cluster with the weights of a global model to the set of nodes;
a module for receiving, from the aggregation node of said at least one cluster, the weights of an aggregate model of said cluster resulting from said learning; and
a module for updating the weights of the global model by aggregation of the received weights of the aggregate model of said at least one cluster.

17. A node belonging to a set of nodes including neural networks having a model of the same structure, of a communication network, said node comprising at least one processor able to:
receive, from an entity of said communication network, before federated learning of the weights of said models of the neural networks of the nodes of said set, in which said nodes locally train their model of neural networks and share the weights of their model with other nodes of said network, information designating a first node from said set as an aggregation node managing an aggregate model for said federated learning and, when said node is said first node, identifiers of the nodes of said cluster of a cluster whose said aggregation node manages said aggregate model.

18. The node of claim 17, further comprising:
a module for receiving, from said entity of said communication network, the weights of a model having said structure, when said node is said aggregation node;
a module for receiving a request to learn the weights of an aggregate model of said cluster from said received weights, when said node is said aggregation node;
an initialization module configured, upon receipt of said learning request, to initialize the weights of the aggregate model of said cluster and the weights of the models of the nodes of said cluster with the received weights, when said node is said aggregation node;
a module for updating the weights of the aggregate model of said cluster, by aggregation of the weights of the models of the nodes of said cluster, trained with local datasets to these nodes, the weights of the models of the nodes of said cluster being replaced by the updated weights of the aggregate model of said cluster after each update, when said node is said aggregation node; and
a module for sending, to said entity of the network, the weights of the aggregate model of said updated cluster, when said node is said aggregation node.

19. A non-transitory computer readable medium having stored thereon instructions which, when executed by a processor, cause the processor to implement the method of claim 1.

20. A non-transitory computer readable medium having stored thereon instructions which, when executed by a processor, cause the processor to implement the method of claim 8.
